(19) United States
(12) Patent Application Publication
(10) Pub. No.: US 2009/0224711 A1
(43) Pub. Date: Sep. 10, 2009

(54) ROTATING ELECTRICAL MACHINE WITH DECOUPLED PHASES

(75) Inventor: Pierre Sardat, Le Raincy (FR)

Correspondence Address: MATTHEW R. JENKINS, ESQ., 2310 FAR HILLS BUILDING, DAYTON, OH, 45419, US

(73) Assignee: VALEO EQUIPEMENTS ELECTRIQUES MOTEUR, Creteil (FR)

(21) Appl. No.: 12/158,095

(22) PCT Filed: Dec. 13, 2006
(86) PCT No.: PCT/FR06/51347

§ 371 Date: Nov. 13, 2008

(30) Foreign Application Priority Data
Dec. 23, 2005 (FR) 05/13296

(51) Int. Cl. H02P 6/14

(52) U.S. Cl. 318/400.27

(57) ABSTRACT

A rotating electrical machine comprising an electromechanical group with n phases which is adapted in such a way as to convert electrical power into mechanical power, and a static converter circuit which is used to supply the electrical power and comprises n pairs of switching circuits mounted in series. Each pair is coupled to a respective phase of the electromechanical group. A first capacitive decoupling element is connected in parallel to each respective pair of switching circuits, and a damping circuit comprising a resistive element and a second capacitive element is connected in parallel to the first decoupling capacitive element of each respective pair of switching circuits.

The present invention relates to rotating electrical machines, in particular alternator starters used for example in motor vehicles.

More particularly, the invention concerns a rotating electrical machine comprising an electromechanical assembly adapted to convert electrical power, in the form of an alternating current, into mechanical power. This assembly comprises a number n of phases, where n is equal to at least 2, an inverter circuit adapted to deliver said alternating current and comprising n pairs of switching circuits connected in series with each other, each pair being coupled to a respective phase of the electromechanical assembly.

The use of such rotating machines is known, in particular within the context of reversible machines of the alternator starter type. In a rotating electrical machine of this type, the electromechanical assembly comprises for example an n-phase synchronous motor, a switching circuit forming an inverter circuit, and a control circuit for controlling the switching circuit. The synchronous motor comprises a stator with a plurality of phases formed by windings, and a rotor mounted able to move with respect to the stator and comprising for example a permanent magnet.

During the use of a machine of this type in starter mode, the switching circuit converts DC electric power, delivered by a battery of a vehicle, into AC electrical power. From this AC electrical power, the stator generates a rotating magnetic field in order to generate a mechanical torque supplied to the motor during starting. It is desirable to produce a large torque in this mode of operation.

However, the control of the switching circuits can be disrupted by electromagnetic signals, capable of causing a malfunction of the control of the motor. This electromagnetic interference can be generated by other devices operating in the vicinity of the rotating electrical machine.

Moreover, the rotating electrical machine can itself also produce electromagnetic interference, which can prove a nuisance for the other devices in the surrounding area.

It is therefore desirable that devices of this type comply with things relating to the EMC (Electromagnetic Compatibility) standard.

The aim of the present invention is in particular to overcome the aforementioned drawbacks by providing a rotating electrical machine that is less sensitive to electromagnetic interference.

To that end, according to embodiments of the invention, a rotating electrical machine of the type in question comprises a first capacitive element which is connected in parallel with each respective pair of switching circuits and a damping circuit, comprising a resistive element and a second capacitive element, which is connected in parallel with the first capacitive element of each respective pair of switching circuits.

By virtue of these provisions, decoupling of the switching circuits of each phase is provided. The rotating electrical machine is thus better protected from electromagnetic attacks and can therefore be used in a more demanding environment. Moreover, the high-frequency components of the current are smoothed by means of these capacitances, thus resulting in a reduction in the amplitude of the harmonics which can disrupt nearby devices (conducted and radiated EMC).

The capacitance of this first capacitive element forms a tuned oscillatory circuit with the inductance of the conductive elements, in particular the inductance of the cables connecting the battery to the inverter circuit. In order to damp oscillations inside this oscillatory circuit caused in particular by voltage drops at switching, the damping circuit is coupled in parallel with each first capacitive element. The resistance of the resistive element of the damping circuit is chosen for optimal damping of these oscillations.

A first function of the second capacitive element is to prevent a supply current which is DC being permanently dissipated by the resistance of the damping circuit. This is because the capacitance acts as an open switch for a DC current, preventing conduction through the resistive element.

In accordance with one embodiment of the invention, the capacitance of the second capacitive element is substantially greater then the capacitance of the first capacitive element.

This is because, as the capacitance of the second capacitive element is greater than the capacitance of the first capacitive element, the latter conducts current for frequencies lower than the resonant frequency of the stray oscillatory circuit. Consequently, the first capacitive element is shunted in order to damp the oscillations by means of the resistance of the resistive element.

More precisely, the value of the capacitance of the second capacitive element is for example substantially equal to or greater than three times the capacitance of the first capacitive decoupling element. It has in fact been established that this constitutes a good compromise between the size of the components and the shunt efficiency at high frequency of the first capacitive element.

According to a variant of the invention, the inverter circuit is coupled to a DC current source by means of conductive elements, said conductive elements having a stray internal inductance.

The damping circuit and the first capacitive element form, with the conductors, an oscillatory circuit. The resistive element of the damping circuit is adapted to attenuate the oscillations within said oscillatory circuit.

The resistance of the resistive element is therefore chosen as a function of the values of the stray inductances and the capacitances, so that the oscillatory circuit is damped optimally.

Advantageously, the resistance of the resistive element can be chosen substantially equal to

$$\sqrt[4]{\frac{{L}^{2}}{{C}_{1} {C}_{2}}}$$

where L is the sum of the stray inductances of the electrical conductors,
C1 is the capacitance of the first capacitive element,
and C2 is the capacitance of the second capacitive element.

This is because this gives a position in the region of the geometric mean of the specific resonant frequencies of each capacitive element coupled to the stray inductances. Damping is optimal for values close to this mean.

Advantageously, the rotating electrical machine can also comprise a control circuit with n pairs of outputs for controlling the n respective pairs of switching circuits, and the control circuit can comprise at least one resistive output element connected to said outputs.

This makes it possible to limit the speed of variation of the voltage at the terminals of the capacitive elements. This is because, during switching, the capacitances are subjected to large voltage variations, which causes large currents to flow. In order to limit these currents, switching from the conducting state to the off state and vice versa is slowed down. This has the advantage of allowing the use of small-sized components, in particular the use of ceramic capacitors. There is consequently a reduction in the total size of the control circuit, which can be truly incorporated in the motor. However, larger switching losses owing to the longer switching time are noted.

According to a variant embodiment, each resistive output element forms, with stray capacitances of the corresponding switching circuit, an RC circuit having a given time constant. The value of the resistive element is then such that said time constant is substantially 5% of a minimum period of the alternating current.

This compromise in fact makes it possible to greatly reduce the size of the capacitive elements without however suffering too large switching losses for the switching circuits.

Similarly, each resistive output element forms, with stray capacitances of the corresponding switching circuit, an RC circuit having a given time constant. The value of the resistive element is then such that a maximum voltage variation at the terminals of the first capacitive element is substantially less than 5V/μs. This allows in particular the use of ceramic capacitors, the size of which is small, and which are sufficient to provide electromagnetic decoupling effectively.

Other characteristics and advantages of the invention will emerge in the course of the following description of one of its embodiments, given by way of a non-limiting example, with reference to the accompanying drawings.

In the drawings:

FIG. 1 is a simplified diagram of a rotating electrical machine in accordance with the invention;

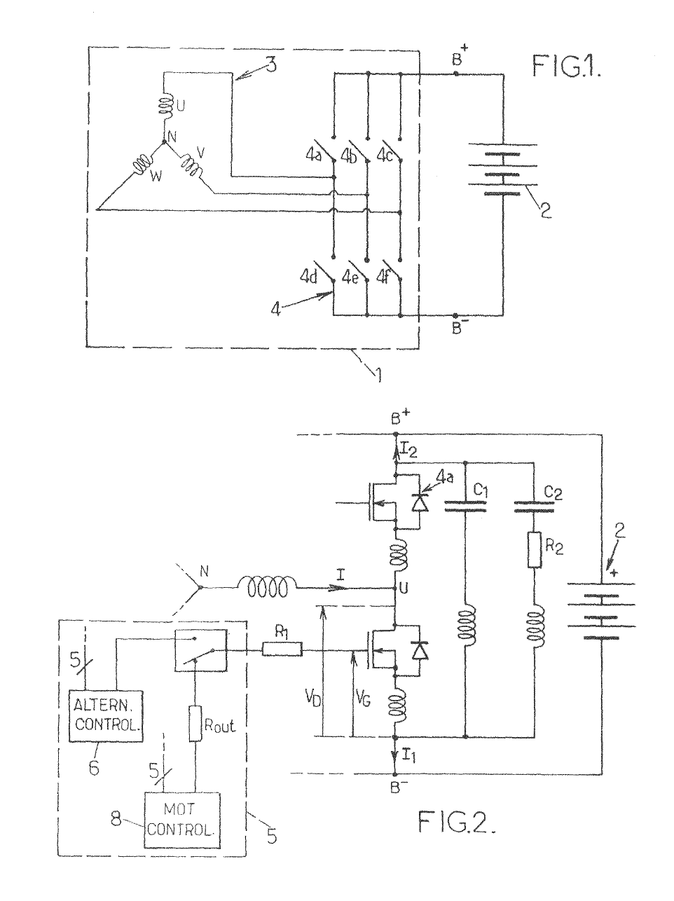

FIG. 2 is a wiring diagram of one phase of the rotating electrical machine of FIG. 1; and

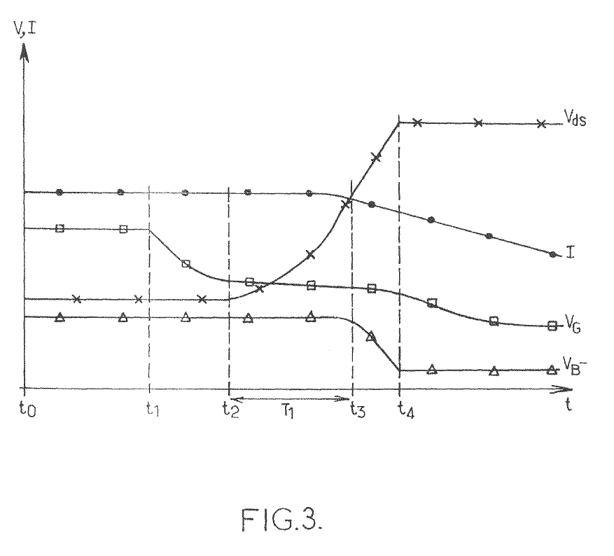

FIG. 3 is a timing diagram depicting the change in signals during switching in the phase of FIG. 2.

In the different figures, the same references designate identical or similar elements.

As depicted in FIG. 1, a rotating electrical machine 1 is supplied by a DC voltage source, for example a battery 2. The rotating electrical machine 1 comprises an electromechanical assembly 3, adapted to convert electrical power into mechanical power. In the example illustrated, it is a three-phase synchronous motor 3 (n=3). If relevant, this motor can be used as an alternator, in particular if the rotating electrical machine 1 is an alternator starter.

Moreover, the rotating electrical machine 1 comprises a three-phase inverter circuit 4, coupled on the one hand to the battery 2 by means of the terminals B+ and B−, and on the other hand to the three-phase motor 3 by means of the phases U, V, W. In the example illustrated, the stator windings are Y-connected, that is to say they have a common terminal, the neutral N. However, the delta structure can also be used. Similarly, the number of phases can be different. An odd number of phases is however preferred.

The inverter 4 comprises six switching circuits 4a to 4f. Each pair of switching circuits is coupled to a respective phase at a common terminal. Thus, the pair 4a-4d has a common terminal U connected to the stator winding U. Similarly, the pair 4b-4e has a common terminal V connected to the stator winding V, and the pair 4c-4f has a common terminal W connected to the stator winding W.

To simplify studying the invention, this will be limited to studying the switching of one phase, for example the phase U with its corresponding pair of switching circuits 4a-4d. FIG. 2 depicts in a simplified manner the pair of switching circuits 4a-4d, with part of the control circuit 5 for the switching circuit 4d. Each switching circuit comprises a similar control circuit which has not been depicted for more clarity.

In the example depicted, the switching circuits 4a and 4d are MOSFETs (Metal Oxide Semiconductor Field Effect Transistors). The control circuit is adapted for control of the electromechanical assembly in alternator mode with the alternator control block 6 (ALTERN. CONTROL.) and control in motor mode with the motor mode control block 8 (MOT. CONTROL.). The control signal is for example multiplexed by a two-input multiplexer 7. A resistive output element Rₒᵤₜ can be connected between the motor control block 8 and the multiplexer 7. The control circuit 5 is coupled with the gate of the transistor 4d by means of a resistor R1.

In accordance with other embodiments of the invention, a first capacitive element C₁ is connected in parallel with the pair of MOSFETs 4a and 4d. This capacitive element makes it possible to decouple the phases and the supply arms connected to the terminals B+ and B−. Thus, the rotating electrical machine 1 is less sensitive to electromagnetic interference which could cause malfunctioning of the MOSFETs 4a and 4d. This is because, without this decoupling capacitance which “absorbs” high frequencies, electromagnetic interference can modify a reference potential, for example the potential at the point B+, then causing the switching of 4a. In this example, the capacitance C₁ has been chosen substantially equal to 220 nF.

However, the first capacitive element C₁ forms, with the total stray inductance L of the conductive elements, modelled by the coils depicted in FIG. 2, an oscillatory circuit, with a resonant frequency approximately equal to

$$\frac{1}{2 Π \sqrt{L \cdot {C}_{1}}} .$$

In order to damp this oscillatory circuit, a resistive element R₂ is placed in parallel with this capacitance.

Next, in order to avoid this resistive element R₂ permanently shunting the pair of MOSFETs, a capacitive element C₂ is placed in series with this resistance. This is because, whilst a DC current brings about the charging of this capacitive element, blocking this arm of the circuit, an AC current can flow through this capacitive element C₂ and be dissipated or damped in the resistance of the resistive element R₂.

The oscillations produced by the oscillatory circuit LC₁ can thus be damped by choosing the capacitance of the second capacitive element so that it is greater than that of the first capacitive element C₁. Preferably, the capacitance C₂ is chosen substantially equal to three times the capacitance C₁, that is in this example 680 nF. This is because, in this case, the second capacitive element C₂ behaves substantially as a closed switch for an AC current close to the resonant frequency of the oscillatory circuit LC₁.

Then, the resistive element R2 damps the oscillations produced in this oscillatory circuit. In order to optimise this damping effect, the resistance R₂ is chosen substantially equal to

$$\sqrt[4]{\frac{{L}^{2}}{{C}_{1} {C}_{2}}} .$$

Thus, at the time of each switching, the overshoots caused by the oscillations have an amplitude which becomes so small that these oscillations cannot cause spurious switching of one of the MOSFETs 4a and 4d. Moreover, steady state is reached quickly.

FIG. 3 is a timing diagram showing the change in different voltages and currents of the circuit of FIG. 2 during the change from the conducting state to the off state of the MOSFET 4d. At the initial state to, the transistor 4a is in the off state and the transistor 4d is in the conducting state. At the instant t₁, the control circuit establishes a low signal at the output connected to the gate of the MOSFET 4d. The gate voltage V_{G} then starts to decrease with a time constant which is a function of the stray capacitances of the MOSFET 4d and the resistances R₁ and Rₒᵤₜ.

When this voltage V_{G} reaches a first threshold, at the instant t₂, this voltage decreases more slowly. This phenomenon is called the “Miller Plateau”, the duration T₁ of which depends on the resistances R₁ and Rₒᵤₜ and the stray capacitances of the MOSFET. During the “course” of this plateau, the internal resistance of the MOSFET 4d starts to increase, and the MOSFET 4d operates in linear conduction mode. As the current I coming from the stator winding of the phase U cannot vary quickly, owing to the inductance of this winding, the drain voltage V_{D} of the MOSFET 4d increases with the increase in the internal resistance of the transistor.

When the voltage V_{D} reaches the supply potential B+ at the instant t₃, the body diode of the MOSFET 4a becomes conducting and the current coming from the stator starts to pass through this diode. Consequently, the current I1 in the MOSFET 4d decreases, and the stray inductance of the conductive elements causes a negative variation of the reference potential B−. This variation is dangerous since the control circuit is connected to this reference.

At the instant t₄, the overvoltages are established, and the MOSFET 4d is in breakdown mode and remains in this conduction mode for the time that the energy stored in the stray inductances of the circuit between the inverter 4 and the battery 2 (FIG. 1) is dissipated in the transistors.

During this switching, the voltage at the terminals of the capacitive elements C₁ and C₂ varies quickly. The direct consequence of this is the formation of a high current in these components. In order to limit this current, the resistive element Rₒᵤₜ is placed so that this additional resistance brings about an increase in the time constant of the discharging of the stray capacitances of the MOSFET 4d. The consequence of this is in particular the lengthening of the duration T₁ of the Miller Plateau. Consequently, the maximum value of

$$( \frac{d V}{d t} ) ,$$

where V is the voltage at the terminals of the capacitive element, can be limited. In this example embodiment, this maximum value is approximately 5V/μs. This value makes it possible to use ceramic capacitors, the size of which is smaller, which allows better integration of the control circuit assembly.

Moreover, limiting the voltage variation makes it possible to avoid large overcurrents, therefore lengthening the service life of the complete circuit.

However, by thus lengthening the Miller Plateau, the switching is slowed down, which leads to larger switching losses. Nevertheless, in this motor operating mode, the main aim is to provide a large torque for starting a heat engine. As the resistive element is placed between the multiplexer 7 and the motor mode control circuit 8, this lengthening of the switching time does not occur in alternator mode, during which it is sought to have optimal energy output.

With this structure, the optimal performance of conversion of mechanical power into electrical power in alternator mode can be retained and in addition good decoupling can be provided in both starter and alternator modes.

1. A rotating electrical machine comprising:
an electromechanical assembly adapted to convert electrical power, in the form of an alternating current, into mechanical power, and comprising n phases, where n is equal to at least two,
an inverter circuit adapted to deliver said alternating current comprising a number n of pairs of switching circuits connected in series with each other, each pair being coupled to a respective phase of said electromechanical assembly,
wherein a first capacitive decoupling element is connected in parallel with each respective pair of switching circuits; and
in that a damping circuit, comprising a resistive element and a second capacitive element, is connected in parallel with said first capacitive decoupling element of each respective pair of switching circuits.

2. The rotating electrical machine according to claim 1, in which a capacitance of said second capacitive element is substantially greater then a capacitance of said first capacitive decoupling element.

3. The rotating electrical machine according to claim 2, in which the value of said capacitance of said second capacitive element is substantially equal to or greater than three times said capacitance of said first capacitive decoupling element.

4. The rotating machine according to claim 1, wherein said inverter circuit is coupled to a DC voltage source by means of conductive elements, said conductive elements having a stray internal inductance, in which said damping circuit and said first capacitive decoupling element form, with said conductive elements, an oscillatory circuit, the value of said resistive element of said damping circuit being adapted to attenuate the oscillations within said oscillatory circuit.

5. The rotating electrical machine according to claim 4, in which the resistance of said resistive element is substantially equal to
$$\sqrt[4]{\frac{{L}^{2}}{{C}_{1} {C}_{2}}}$$
where L is the sum of the stray inductances of said conductive elements,
C1 is a capacitance of said first capacitive decoupling element,
and C2 is a capacitance of said second capacitive element.

6. The rotating electrical machine according to claim 1, wherein said rotating electrical machine further comprises a control circuit with n pairs of outputs for controlling n pairs of switching circuits, respectively, and in which said control circuit comprises at least one resistive output element connected to said n pairs of outputs.

7. The rotating electrical machine according to claim 6, wherein each resistive output element forms, with stray capacitances of a corresponding switching circuit, an RC circuit having a given time constant, and in which the value of said resistive element is such that said given time constant is substantially greater than approximately 5% of a maximum period of an alternating current.

8. The rotating electrical machine according to claim 6, wherein each resistive output element forms, with stray capacitances of a corresponding switching circuit, an RC circuit having a given time constant, and in which the value of said resistive element is such that a maximum voltage variation at the terminals of said first capacitive decoupling element is substantially less than approximately 5V/μs.

9. The rotating electrical machine according to claim 7, wherein each resistive output element forms, with stray capacitances of a corresponding switching circuit, an RC circuit having a given time constant, and in which the value of said resistive element is such that a maximum voltage variation at the terminals of said first capacitive decoupling element is substantially less than approximately 5V/μs.

10. The rotating machine according to claim 2, wherein said inverter circuit is coupled to a DC voltage source by means of conductive elements, said conductive elements having a stray internal inductance, in which said damping circuit and said first capacitive decoupling element form, with said conductive elements, an oscillatory circuit, the value of said resistive element of said damping circuit being adapted to attenuate the oscillations within said oscillatory circuit.

11. The rotating machine according to claim 3, wherein said inverter circuit is coupled to a DC voltage source by means of conductive elements, said conductive elements having a stray internal inductance, in which said damping circuit and said first capacitive decoupling element form, with said conductive elements, an oscillatory circuit, the value of said resistive element of said damping circuit being adapted to attenuate the oscillations within said oscillatory circuit.

12. The rotating electrical machine according to claim 2, wherein said rotating electrical machine further comprises a control circuit with n pairs of outputs for controlling n pairs of switching circuits, respectively, and in which said control circuit comprises at least one resistive output element connected to said n pairs of outputs.

13. The rotating electrical machine according to claim 3, wherein said rotating electrical machine further comprises a control circuit with n pairs of outputs for controlling n pairs of switching circuits, respectively, and in which said control circuit comprises at least one resistive output element connected to said n pairs of outputs.

14. The rotating electrical machine according to claim 4, wherein said rotating electrical machine further comprises a control circuit with n pairs of outputs for controlling n pairs of switching circuits, respectively, and in which said control circuit comprises at least one resistive output element connected to said n pairs of outputs.

15. The rotating electrical machine according to claim 5, wherein said rotating electrical machine further comprises a control circuit with n pairs of outputs for controlling n pairs of switching circuits, respectively, and in which said control circuit comprises at least one resistive output element connected to said n pairs of outputs.
